(19) United States
(12) Patent Application Publication
(10) Pub. No.: US 2015/0034524 A1
(43) Pub. Date: Feb. 5, 2015

(54) SEALING SHEET FOR CLOSING A CONTAINER-DEFINING SHEET RECONFIGURABLE BETWEEN DIFFERENT DOSAGE SCHEDULES

(71) Applicant: 9155-0020 QUÉBEC INC., Granby (CA)

(72) Inventors: Michel BOUTHIETTE, Granby (CA); Etienne BOUTHIETTE, Montreal (CA)

(21) Appl. No.: 14/448,448

(22) Filed: Jul. 31, 2014

(30) Foreign Application Priority Data
Jul. 31, 2013 (CA) 2822575

(51) Int. Cl. A61J 7/04; A61J 7/00; G06F 19/00; A61J 1/03

(52) U.S. Cl. CPC A61J 7/04; A61J 1/03; A61J 7/0069; G06F 19/322
USPC 206/534; 206/538; 705/3

(57) ABSTRACT

Disclosed is an improved sealing sheet for use to close a container-defining sheet having a top surface comprising a given number of spaced apart cavities embossed therein, each of the cavities being upwardly opened and thus defining a container that is surrounded by a flange that is part of the top surface of the container-defining sheet. In a first configuration, the number of cavities made in the container-defining sheet is thirty-two, positioned in order to define eight rows and four columns. A row of containers is removable from the container-defining sheet towards a second configuration in which the number of cavities made in the container-defining sheet is twenty-eight. The set of containers can more efficiently cover a prescription that has to be administered over a monthly period, under different dosage schedule scenarios, while reducing unused sections of the resulting blister packs.

### BACKGROUND OF THE INVENTION

The present invention relates to an improved sealing sheet for use to close a plurality of containers formed in a container-defining sheet, especially but not exclusively for the storage of individual pills.

The invention also relates to a set of individual pill containers comprising a container-defining sheet made of plastic material and defining a plurality of individual pill containers closed by the above-mentioned improved sealing sheet.

### BRIEF DESCRIPTION OF THE PRIOR ART

It is of common practice in the pharmaceutical field to prepare sets of individual containers containing pills and/or tablets to be administered to a patient. Each of these containers contains pills and/or tablets that the patient has to take together at the same time during the day over a given period of time (preferably one week).

To prepare such sets of individual pill containers for use by a patient, it is also of common practice to use a sheet of plastic material in which a plurality of cavities are embossed. Each of these cavities defines a small upwardly opened container that can be filled with pills. After filling, all the containers are closed by means of a sealing sheet on which all desirable indications can be printed, like the patient's name, the date and hour of administration, etc. As it can be understood, the indications are printed and formatted onto the sealing sheet so that each group of information referring to a given container is positioned in regard to said container. Tearing lines are provided on both the container-defining sheet and the sealing sheet to permit easy separation of the individual pill containers.

For further information as to the structure, manufacture and use of such sets of individual pill containers, reference can be made to U.S. Pat. No. 5,788,079 and its Canadian counterpart no. 2,207,045 which both name the present inventor, and to all the prior art that was cited during their prosecution.

In practice, the sealing sheet used to close the containers of these known sets of individual pill containers can be made of plastic material and be thermosealed onto the container-defining sheet. Alternatively, as disclosed in the above-mentioned US and Canadian patents naming the present inventor, the sealing sheet can be made of paper or similar material and be glued onto the container-defining sheet. For this purpose, the sealing sheet comprises a top layer having a lower surface covered with a pressure sensitive adhesive glue and a bottom layer having an upper surface detachably fixed to the lower surface of the top layer by means of the adhesive glue. The bottom layer is peelable from the lower surface of the top layer to allow fixation of it onto the top surface of the container-defining sheet. Advantageously, this bottom layer has tearing lines punched into it in such a manner and position as to leave parts of it glued onto the bottom surface of the top layer in the form of a number of bottom pieces equal to the given number of cavities made in the container-defining sheet when the sealing sheet is peeled off. Each of these bottom pieces are shaped, sized and positioned so as to extend over a corresponding cavity of the container-defining sheet when the sealing sheet is properly applied to and glued on the flanges of the top surface of the container-defining sheet. These bottom pieces thus prevent the pill(s) stored in each of the containers from coming into contact with the adhesive glue.

As another example of such a sealing sheet, reference can be made to U.S. Pat. No. 6,382,420 or 7,308,984 which also names the present inventor.

All of these existing sealing sheets are efficient. However, sealing sheets that are used for the administration of pills to patients according to a daily regimen at different times of the day are typically provided to be used over a seven day period. If pills are administered at four different times per day, this results in a sealing sheet and a set of individual pill containers totalling 28 containers. Such a configuration is not practical if one wants to use such a system in association with a prescription where individual pill containers are used only once per day but over a complete month period of 29 to 31 days.

Certain blister packs have been developed have been developed to cover a 31-day period. However, these blister packs have been typically developed to cover a single daily administration of a medicament.

Blister packs to cover a period of a week are typically developed to cover a dosage schedule with the administration of a medicament up to four times per day. This weekly blister pack can be reconfigured to be used over a 14-day period if the dosage schedule is reduced with an administration of a medicament twice per day, or over a 28-day period if the dosage schedule is reduced to a single administration of a medicament per day. A computer program can be used to adapt the labelling of these blister packs to cover the above-mentioned different scenarios on a standard-sized sheet. This sheet can be printed on standard printers. This choice among different dosage schedules for a commonly sized blister pack is appreciated by pharmacists, because of the resulting reduction in waste.

However, the commonly-sized blister pack with 28 containers becomes troublesome to use when attempting to cover a prescription that has to be administered over a monthly period. If a prescription is administered 3 or 4 times per day, five 28-container blister packs are required, wherein the fifth blister pack is almost empty. If a prescription is administered twice per day, three 28-container blister packs are required, wherein the third blister pack is almost empty. If a prescription is administered once per day, two 28-container blister packs are required, wherein the second blister pack is almost empty.

Consequently, there is a need for a sealing sheet and a container-defining sheet that can more efficiently cover a prescription that has to be administered over a monthly period, under different dosage schedule scenarios, while reducing unused sections of the resulting blister packs.

### SUMMARY OF THE INVENTION

An object of the present invention is to address the above-mentioned need.

More particularly, the present invention provides a sealing sheet for use to close a container-defining sheet having a top surface comprising a given number of spaced apart cavities embossed therein, each of said cavities being upwardly opened and thus defining a container that is surrounded by a flange that is part of the top surface of said container-defining sheet. The sealing sheet comprises:
a top layer having an upper surface and a lower surface, the lower surface being covered with a pressure sensitive adhesive glue; and
a bottom layer having an upper surface detachably fixed to the lower surface of the top layer by means of said adhesive glue, the bottom layer being peelable from the lower surface of the top layer to allow fixation of the sealing sheet onto the top surface of the container-defining sheet, in order to close the containers defined in the same, said bottom layer having tearing lines punched into it in such a manner and position as to leave parts of the bottom layer glued onto the bottom surface of the top layer in the form of a number of bottom pieces equal to the given number of cavities made in the container-defining sheet when the sealing sheet is peeled off, each of the bottom pieces are shaped, sized and positioned so as to extend over a corresponding cavity of the container-defining sheet when the sealing sheet is properly applied to and glued on the flanges of the top surface of the container-defining sheet, the bottom pieces thus preventing any element stored in the containers from coming into contact with the adhesive glue,
the containers defined by the cavities of the container-defining sheet being positioned to form rows and columns,
each row being identifiable with a daily regimen of elements that are storable in the container-defining sheet,

the improvement wherein, in a first configuration, the number of bottom pieces equal to the given number of cavities made in the container-defining sheet is thirty-two, positioned in order to define eight rows and four columns, wherein, at least one row of containers is removable from the container-defining sheet towards a second configuration in which the number of bottom pieces equal to the given number of cavities made in the container-defining sheet is twenty-eight and wherein each row thereby contains four containers corresponding to four different times the elements are to be dispensed from the container.

According to the present invention, there is also provided a set of individual pill containers comprising:
a container-defining sheet made of plastic material, said container-defining sheet having a top surface comprising a given number of spaced apart cavities embossed therein, each of said cavities being upwardly opened and thus defining a container, each of said containers being surrounded by a flange, each of the flanges that are not directly adjacent to one side of the container-defining sheet being provided with a centrally positioned tearing line so to make it possible to detach each of the containers from the adjacent containers and thus from the container-defining sheet whenever desired, and
a sealing sheet made of paper and positioned on top of the top surface of the containing-defining sheet in order to close each of said containers, said sealing sheet being shaped and sized to cover at least all its containers and their surrounding flanges, said sealing sheet being detachably attached to the container-defining sheet by means of a pressure sensitive adhesive glue and being provided with tearing lines positioned to be in superposition on top of the tearing lines of the container-defining sheet to make it possible to tear said sealing sheet into a number of cover pieces corresponding to the number of said containers and thus to detach each of said containers without having to open the same; said sealing sheet comprising:
   a top layer made of paper and having an upper surface and a lower surface, said lower surface being covered with the pressure sensitive adhesive glue; and
   a bottom layer detachably fixed to the lower surface of the top layer by means of said adhesive glue, said bottom layer being peelable from the lower surface of the top layer to allow fixation of the sealing sheet onto the top surface of the container-defining sheet in order to close the containers of the same, said bottom layer having tearing lines punched into it in such a manner and position as to leave parts of said bottom layer glued onto the bottom surface of the top layer in the form of a number of bottom pieces equal to the given number of cavities made in the container-defining sheet when the sealing sheet is peeled off, each of the said bottom pieces being shaped, sized and positioned so as to extend over a corresponding cavity of the container-defining sheet when the sealing sheet is properly applied to and glued on the flanges on the top surface of said container-defining sheet, such bottom pieces preventing any element stored in the containers from becoming into contact with the adhesive glue;

the containers defined by the cavities of the container-defining sheet being positioned to form rows and columns;

each row or column being identifiable with a daily regimen of elements that are storable in the container-defining sheet;

the improvement wherein, in a first configuration, the number of bottom pieces equal to the given number of cavities made in the container-defining sheet is thirty-two, positioned in order to define eight rows and four columns, wherein, at least one row of containers is removable from the container-defining sheet towards a second configuration in which the number of bottom pieces equal to the given number of cavities made in the container-defining sheet is twenty-eight and wherein each row thereby contains four containers corresponding to four different times the elements are to be dispensed from the container.

According to the present invention, there is also provided a computer program for labeling a sealing sheet as described above, the computer program tangibly stored on a non-transitory computer-readable medium, containing instructions for causing a computer to:
select at least one prescription associated with a patient record, the patient record for each patient including a patient's name, and the at least one prescription, wherein each prescription is to be administered according to a dosage schedule selected from the group comprising:
   a first dosage form including at least one medicament taken once daily;
   a second dosage form including two groups of medicaments, each group taken at a separate time daily;
   a third dosage form including three groups of medicaments, each group taken at a separate time daily; and
   a fourth dosage form including four groups of medicaments, each group taken at a separate time daily;
and;
print instructions for administration of the selected at least one prescription on the top surface of at least one sealing sheet wherein:
   the selected at least one prescription is printable on one single sealing sheet upon selection of the first dosage form;
   the selected at least one prescription is printable on two sealing sheets upon selection of the second dosage form;
   the selected at least one prescription is printable on four sealing sheets upon selection of the third dosage form; and
   the selected at least one prescription is printable on four sealing sheets upon selection of the fourth dosage form.

This invention and its numerous advantages will be better understood upon reading the following non restrictive description of preferred embodiments thereof, made with reference to the accompanying drawings.

### BRIEF DESCRIPTION OF THE DRAWINGS

FIG. 1A is a perspective view of the sealing sheet of an improved set of individual pill containers according to a preferred embodiment of the invention; FIG. 1B is a perspective view of the container-defining sheet of an improved set of individual pill containers according to a preferred embodiment of the invention.

FIG. 2 is a top view of a container-defining sheet according to a preferred embodiment of the invention;

FIGS. 3A to 3D is a top view of four sealing sheets for use with a container defining sheet in accordance with a first preferred embodiment of the present invention, for a patient using 4 different prescriptions per day over a complete monthly period, and wherein a daily regimen is on a common row of the sealing sheet;

FIGS. 4A to 4D are a top view of four sealing sheets for use with a container defining sheet in accordance with a second preferred embodiment of the present invention, for a patient using 4 different prescriptions per day over a complete monthly period, and wherein each different prescription is on a corresponding sealing sheet;

FIGS. 5A to 5D are a top view of four sealing sheets for use with a container defining sheet in accordance with a third preferred embodiment of the present invention, for a patient using 3 different prescriptions per day over a monthly period;

FIGS. 6A and 6B are a top view of four sealing sheets for use with a container defining sheet in accordance with a forth preferred embodiment of the present invention, for a patient using 2 different prescriptions per day over a monthly period.

### DESCRIPTION OF A PREFERRED EMBODIMENT OF THE INVENTION

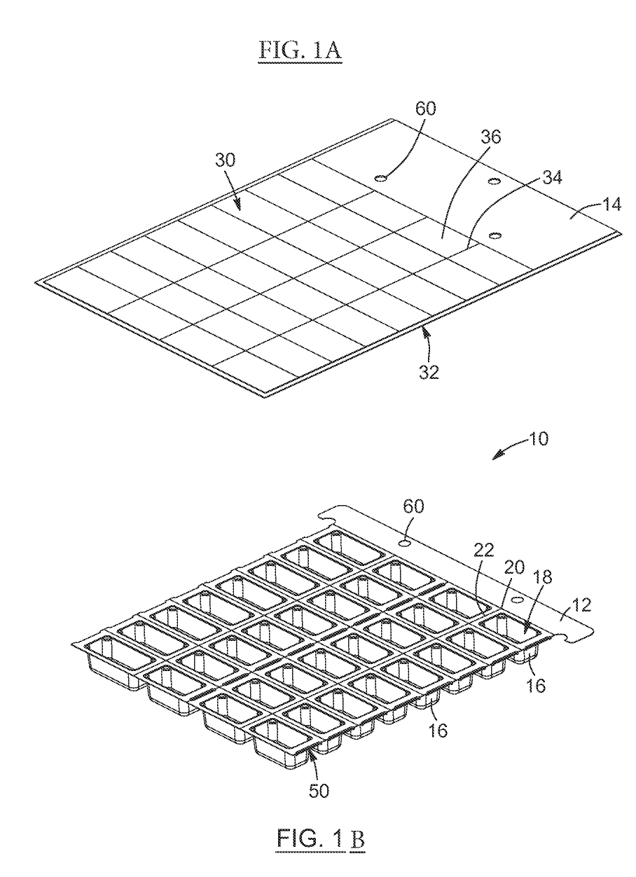

As indicated hereinabove, the present invention relates to an improvement made to the structure of a sealing sheet for use to seal a container-defining sheet like those especially devised to form sets of individual pill containers for use in pharmacies or hospitals. An exploded perspective view of such a set of individual pill containers according to a preferred embodiment of the invention is illustrated in FIG. 1. This set which is numbered 10 in the drawings, basically comprises a container-defining a sheet 12 and a sealing sheet 14 intended to be attached on top of the container-defining sheet 12.

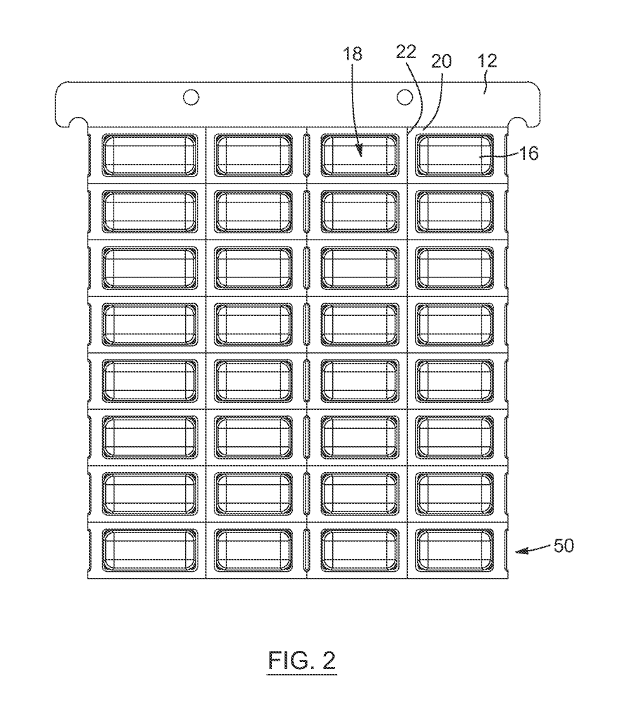

The container-defining sheet 12 is preferably made of a plastic material and has a top surface comprising a given number of spaced apart cavities 16 embossed therein. Each cavity 16 is upwardly opened and thus defines a container 18 which is surrounded by a flange 20. As better shown in FIG. 2, each of the flanges 20 which is not directly adjacent to one external side of the container-defining sheet 12 is provided with a centrally positioned tearing line 22 so as to make it possible to detach each of the containers 18 from all the adjacent containers and thus from the container-defining sheet 12 whenever desired.

The sealing sheet 14 is preferably made of paper and devised to be positioned on top of the top surface of the container-defining sheet 12 in order to close each of the containers.

The sealing sheet 14 comprises a top layer 30 which has an upper surface and a lower surface covered with a pressure-sensitive adhesive glue. The sealing sheet 14 also comprises a bottom layer 32 that is detachably fixed to the lower surface of the top layer 30 by means of the adhesive glue. The bottom layer 32 is devised to be peelable from the lower surface of the top layer 30 in order to allow fixation of the sealing sheet 14 on to the top surface of the container-defining sheet 12 in order to close all the containers 18 made in this sheet 12. Similarly to the sealing sheet disclosed in U.S. Pat. No. 8,181,784, the bottom layer 32 of the sealing sheet has tearing lines that are punched into it in such a manner and position as to leave parts of the bottom layer 32 glued onto the bottom surface of the top layer 30 in the form of a number of bottom pieces equal to the number of cavities 16 made in the container-defining sheet 12 when the sealing sheet 14 is peeled off. Each of the bottom pieces is shaped, sized and positioned so as to extend over a corresponding cavity 16 of the container-defining sheet 12 when the sealing sheet is properly applied to and glued on the flanges 20 located on the top surface of the container-defining sheet 12. As a result, these bottom pieces prevent any element like pills stored in the containers 18, from coming into contact with the adhesive glue that was originally applied to all the adjacent surfaces of the top and bottom layers 30 and 32 of the sealing sheet 14.

As better shown in FIG. 2, the containers 18 defined by the cavities 16 of the container-defining sheet 12 are positioned to form rows and columns.

Of course, when the container-defining sheet 12 is devised so as to allow each of its containers to be detached as was disclosed above and is illustrated in the drawings, the top layer 30 of the sealing sheet 14 must have tearing lines 34 punched therein in such a manner and position as to be in line with the tearing lines 22 of the container-defining sheet 12, in order to allow the top layer 30, once glued onto the flanges 20 on top of the container-defining sheet 12, to be splitted into a number of cover pieces 36 equal to the number of containers 18. Such is actually necessary to allow detachment of each of the containers 18 from the container-defining sheet 12 while keeping the so-detached containers closed.

In accordance with the present invention and as shown in FIGS. 1 and 2, the set 10 of individual pill containers disclosed hereinabove, is improved in that in a first configuration, the number of cover and bottom pieces equal to the given number of cavities 16 made in the container-defining sheet is thirty-two, positioned in order to define eight rows and four columns. Each row is identifiable with a daily regimen of elements that are storable in the container-defining sheet. Each row thereby contains four containers 18 corresponding to four different times the elements are to be dispensed from the container. At least one row 50 of containers is removable from the container-defining sheet 12 towards a second configuration in which the number of bottom pieces equal to the given number of cavities 16 made in the container-defining sheet is twenty-eight. Hence the set of individual pill containers can be reconfigured into a traditional set of pill containers covering a weekly period.

In one embodiment of the present invention, the rows of containers removable from the container-defining sheet are frangibly connected to the container-defining sheet.

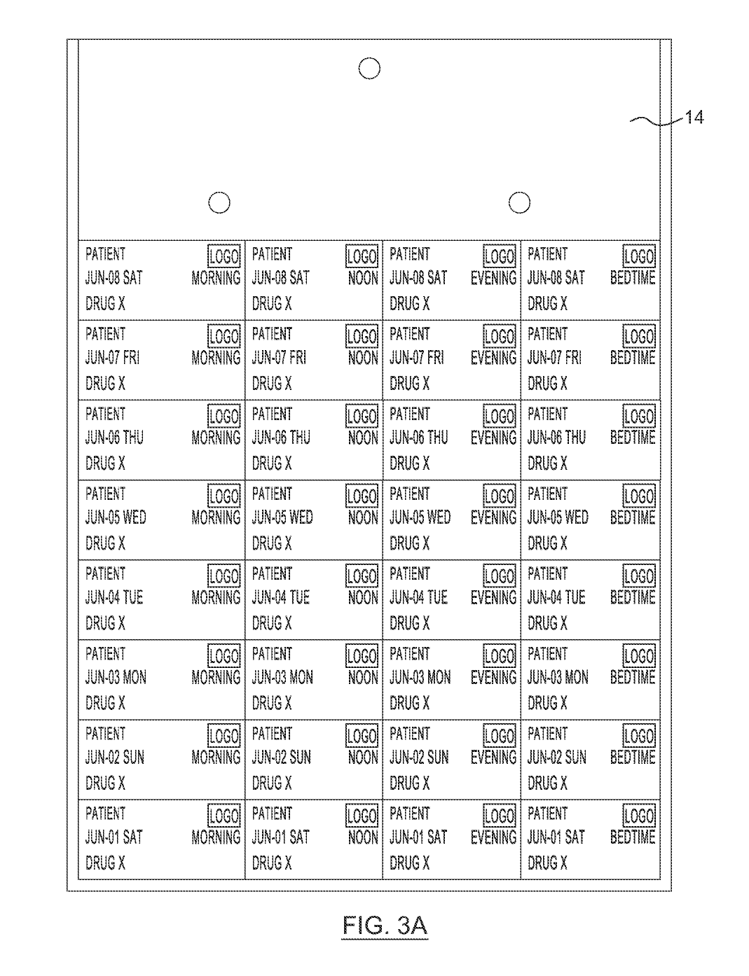

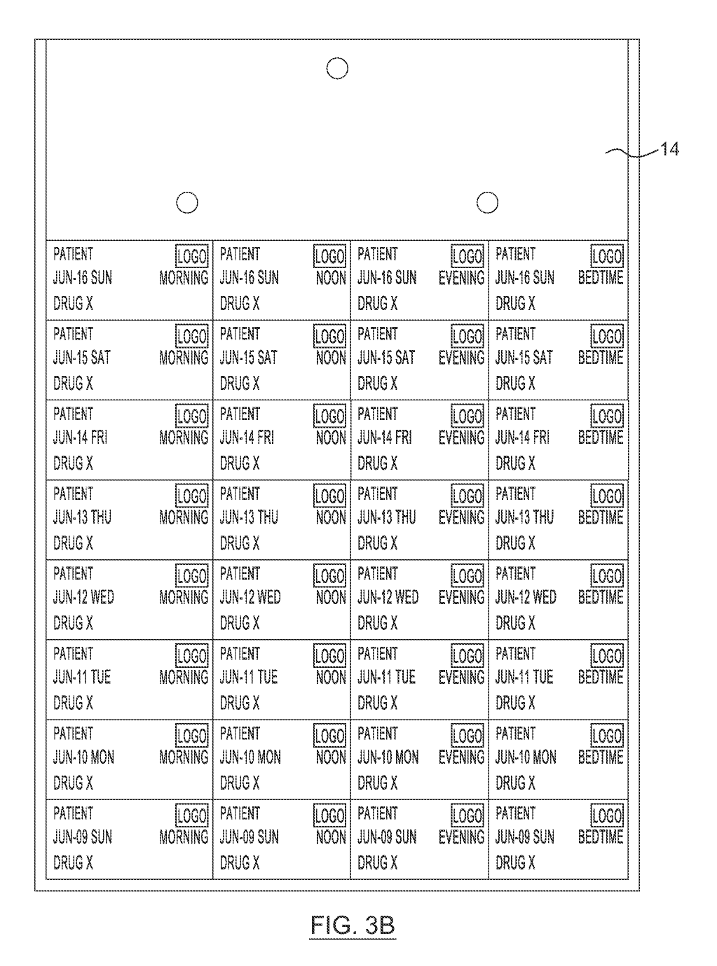

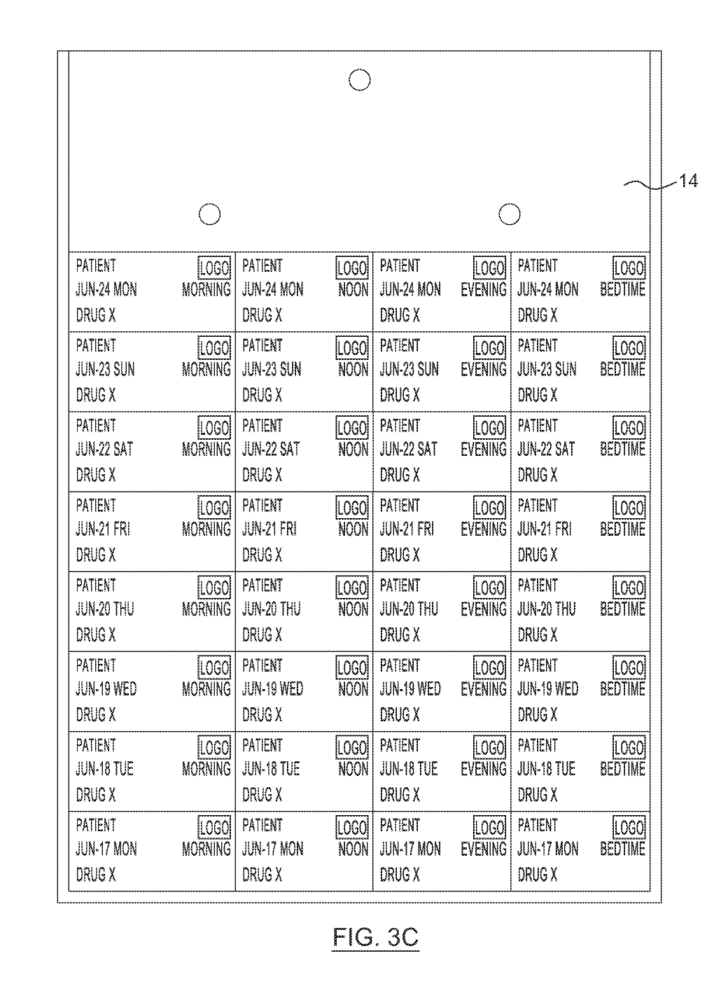

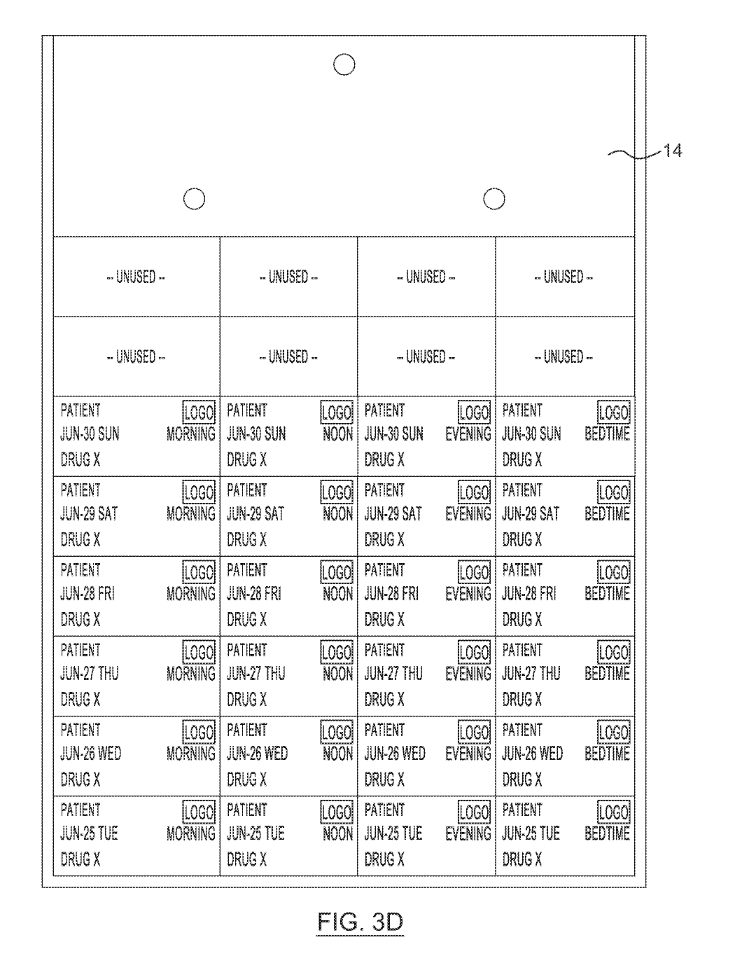

In accordance with a particularly preferred embodiment of the invention, as shown for example in FIG. 3A, the top surface 30 of the sealing sheet 14 includes information printed on it in such a manner as to be positioned on top of each cover piece and thus to correspond to what is located in the corresponding container 18.

In the preferred embodiments illustrated in the accompanying drawings, which is a set for individual pill containers for use in the pharmaceutical field, the sealing sheet 14 is devised to form a corresponding number of cover pieces each of which can be printed with relevant information as to the content of the corresponding container, and the date and, in certain scenarios, the hour the pills contained therein must be taken.

Such particular application is of course devised for use in the medical field, when pills and/or tablets must be administered every day at different periods of time. An example of such printing is illustrated in FIGS. 3A to 3D. As to the way such printing can be done and its advantage, reference can be made to U.S. Pat. No. 5,788,079 naming the present inventor, which has already been mentioned hereinabove.

Of course, it may be understood that, for other applications, the kind of printing and the number of containers may vary.

As also shown in the FIGS. 1 and 2, the sealing sheet 14 and the top surface of the container-defining sheet 12 are advantageously provided with positioning means such as holes 60 that may cooperate with pins extending from a recessed support (not shown) in order to ensure proper positioning of both of them with respect to each other during installation and exact superimposition of the bottom pieces of the sealing sheet on top of the corresponding cavities 16 and with all the tearing lines of the top layer of the sealing sheet in alignment with the tearing lines of the container-defining sheet 12. As to the way such can be done, reference can again be made to U.S. Pat. No. 5,788,079.

Thus, it may be noted that the sealing sheet 14 according to the invention is very simple yet efficient in structure. It provides easy and safe access to the elements stored in the container-defining sheet 12 with a substantial reduction of the risk that such elements comes into contact with the glue used to attach the sealing sheet. Moreover, it is quite easy to manufacture and assemble.

However, an important improvement in the sealing sheet and container defining sheet as described above is the way in which it can more efficiently cover a prescription that has to be administered over a monthly period, under different dosage schedule scenarios, while reducing unused sections of the resulting blister packs.

The set for individual pill containers shown in FIGS. 1 and 2 provides 32 containers, which can be used over a period of up to 32 days, 16 days or 8 days depending on the dosage schedule associated with the pills. If a patient needs medication at four different times per day over a monthly period, four sets of 32 pill containers are required, as illustrated in FIGS. 3A to 3D.

FIGS. 3A to 3D illustrate a scenario wherein all medication required for a chosen day is available on a same row of a set of pill containers. This row can be removed from the set if the patient wants to carry his daily medication with him, without carrying a full month's worth of prescriptions. This represents an advantage over previous sets of 28 pill containers which would have required 5 sets of pill containers to provide the same coverage for a similar dosage schedule.

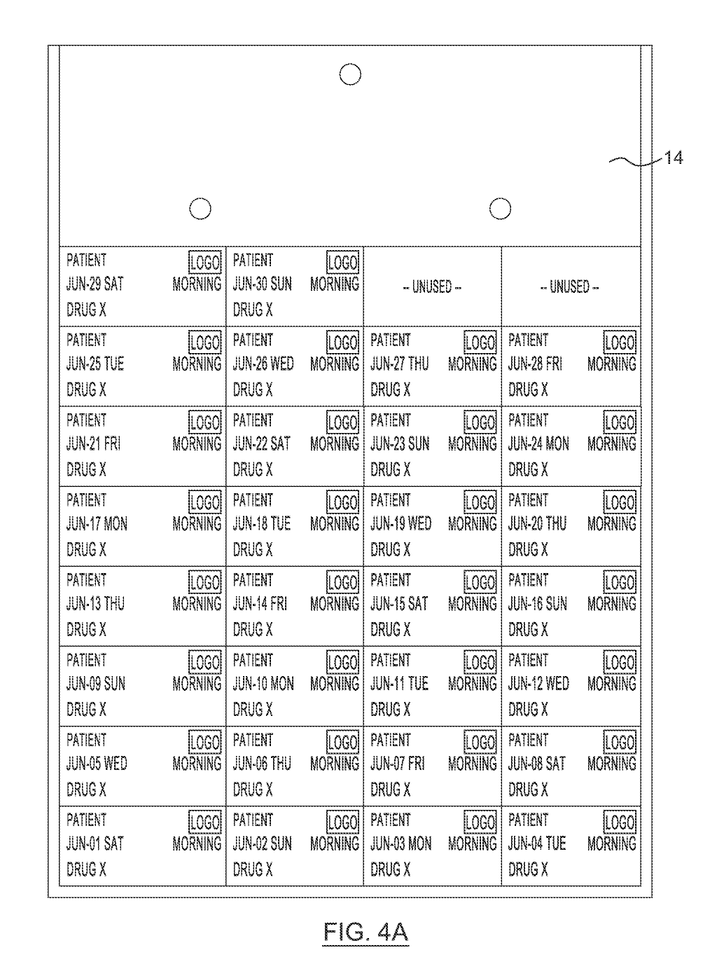

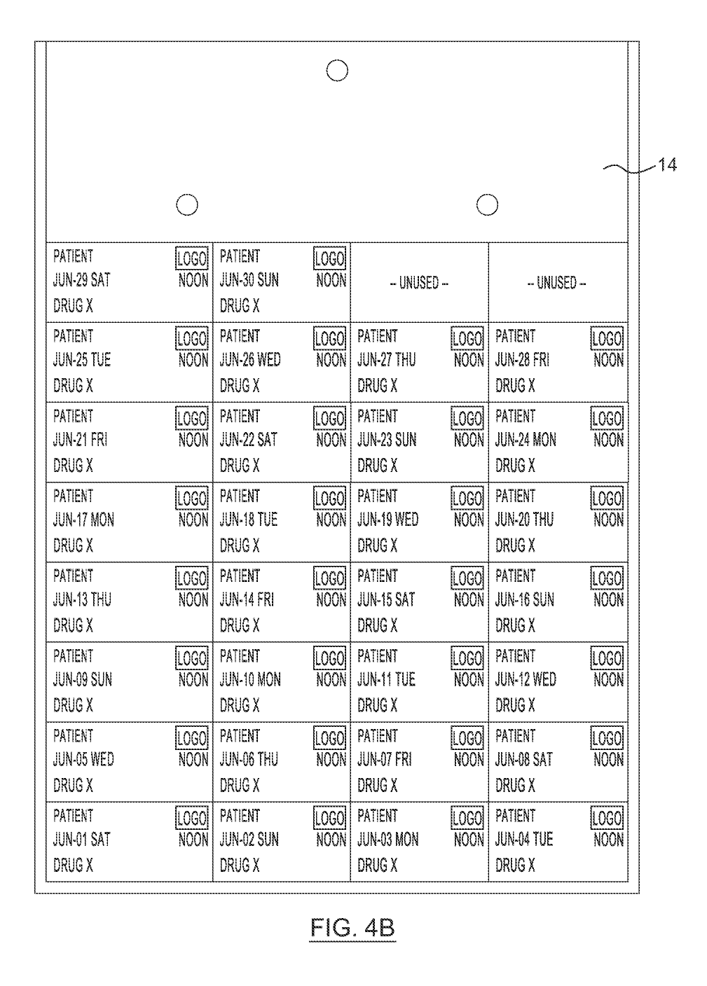

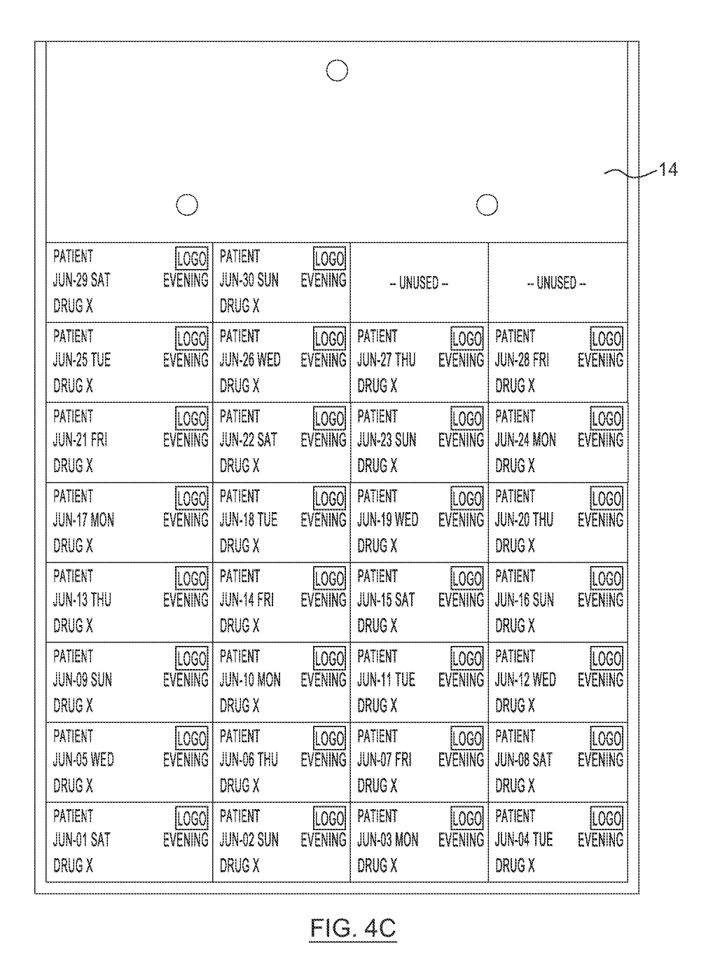

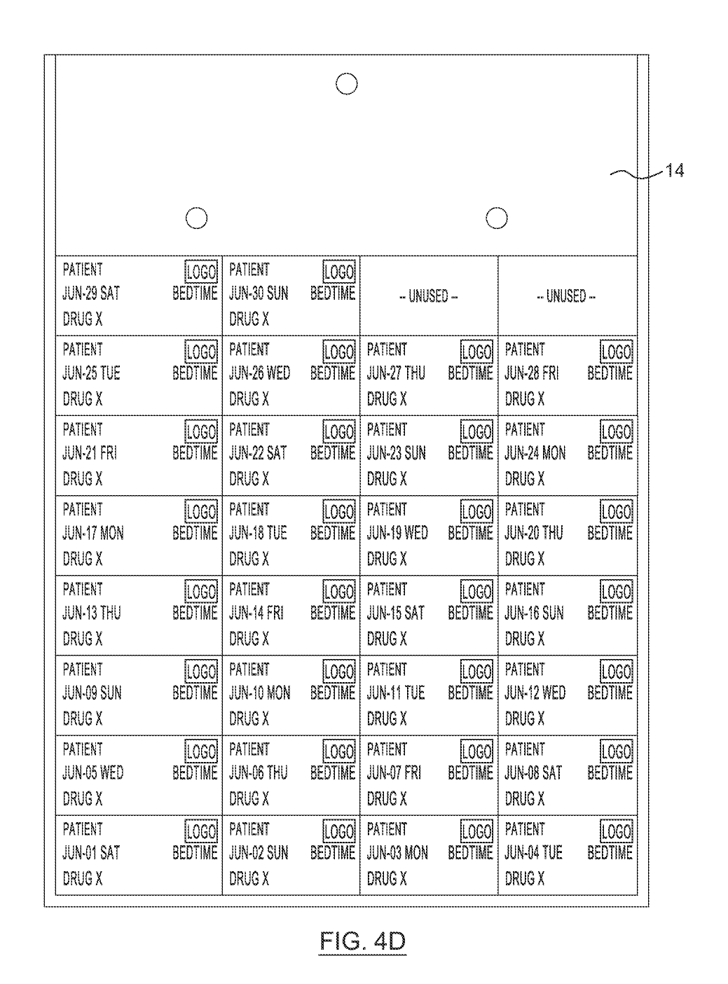

FIGS. 4A to 4D illustrate a scenario where a patient needs medication at four different times per day over a monthly period. Once again, four sets of 32 pill containers are required. However, each set of pill containers is associated with the time of day at which the prescription is taken, for example, morning (FIG. 4A), noon (FIG. 4B), evening (FIG. 4C) and bedtime (FIG. 4D).

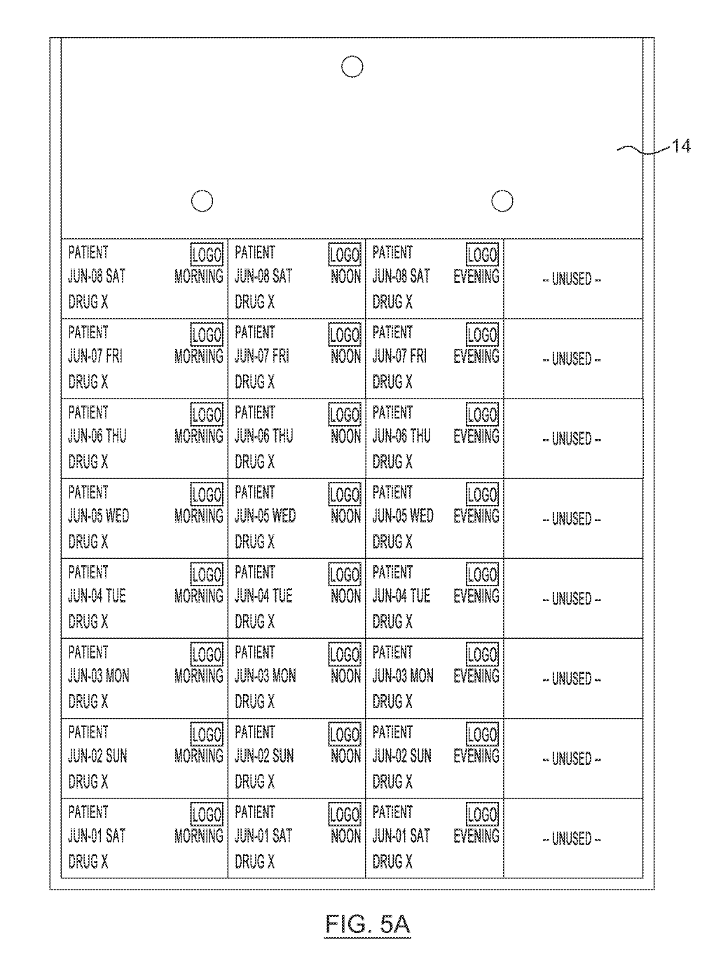

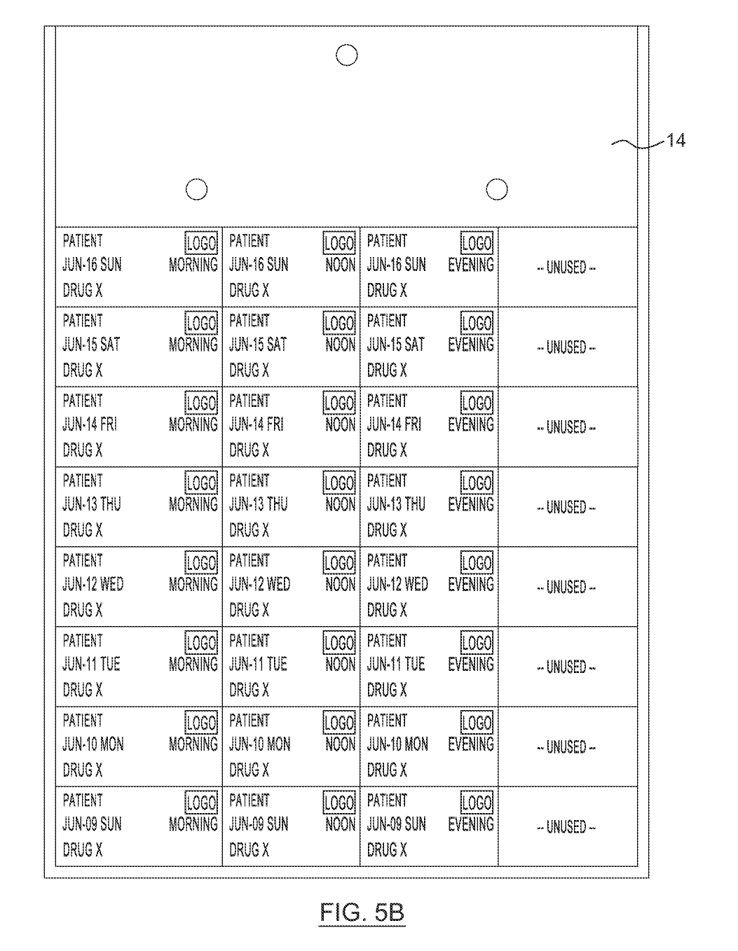

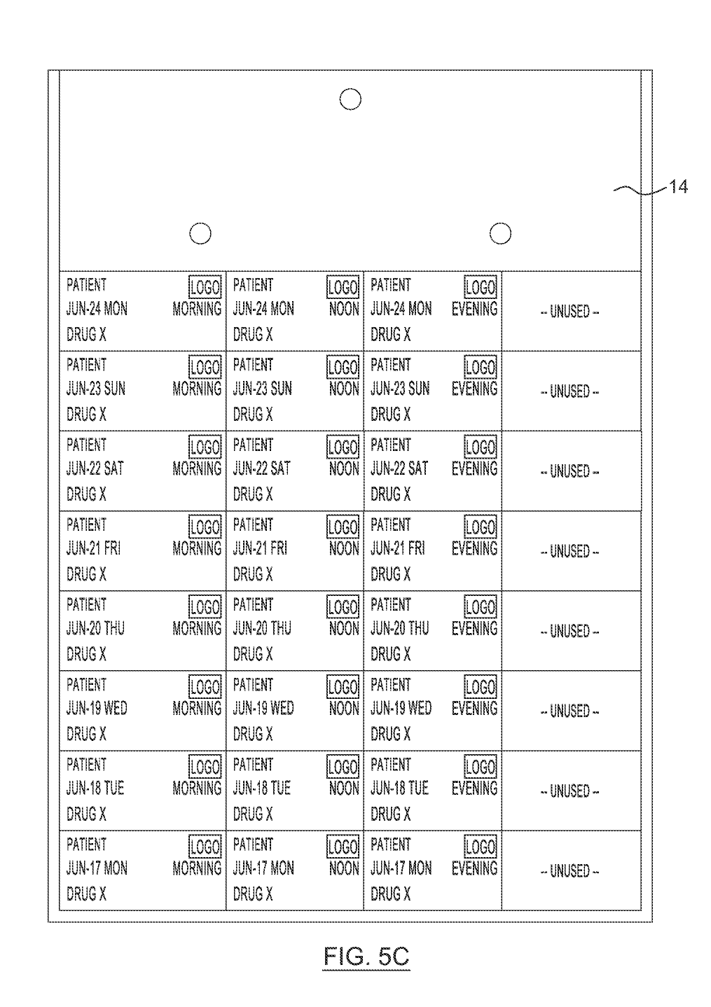

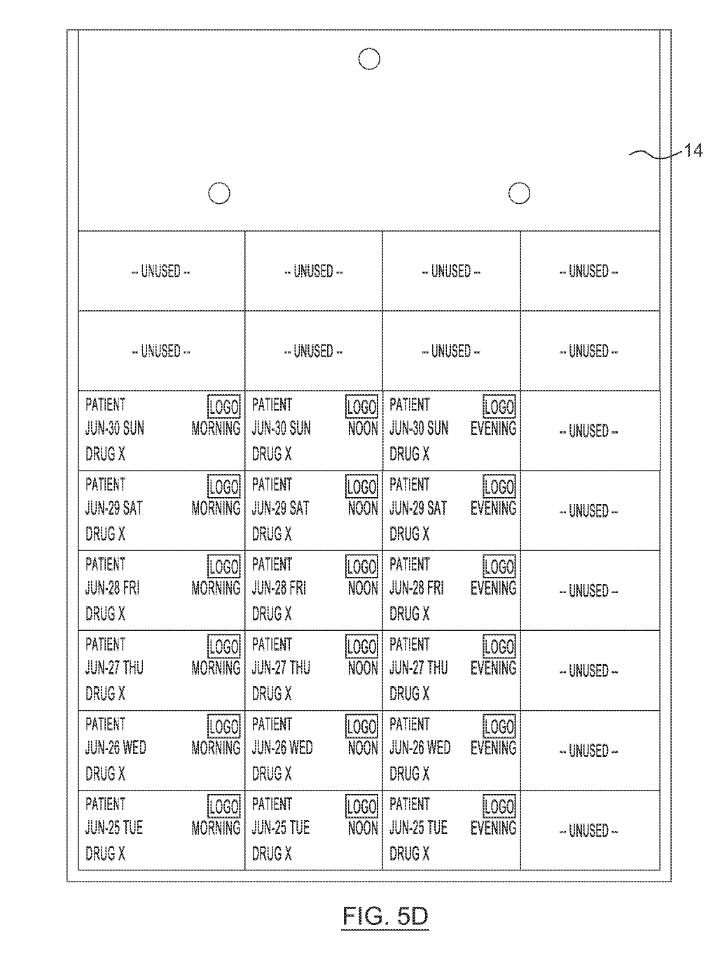

FIGS. 5A to 5D illustrate a scenario where a patient needs medication at three different times per day over a monthly period. Once again, four sets of 32 pill containers are required.

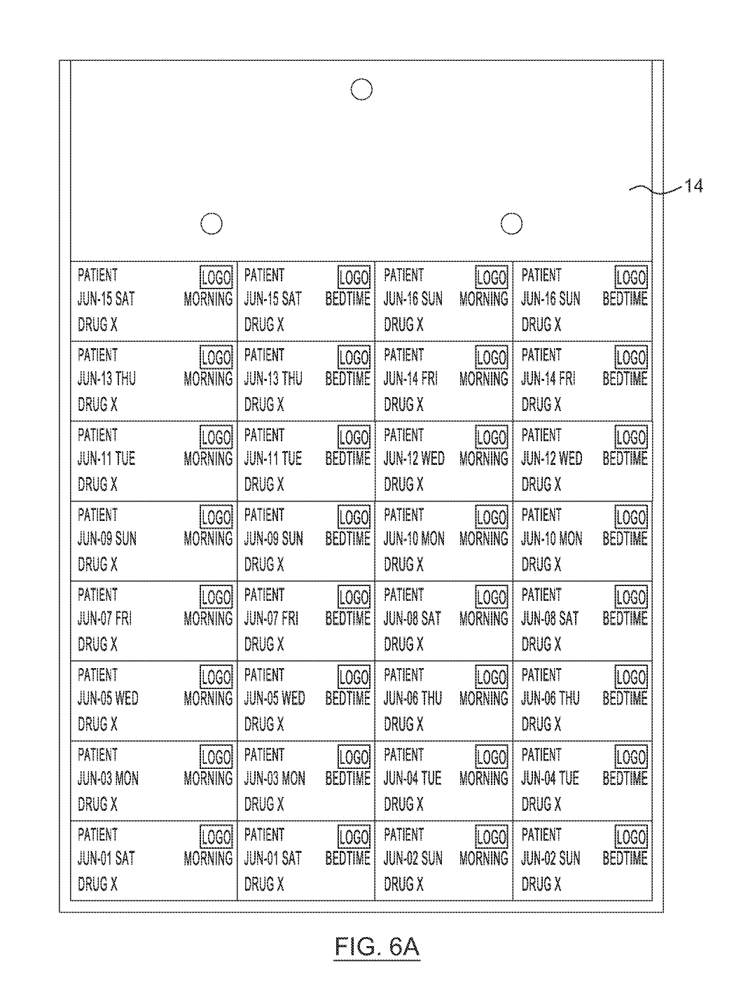

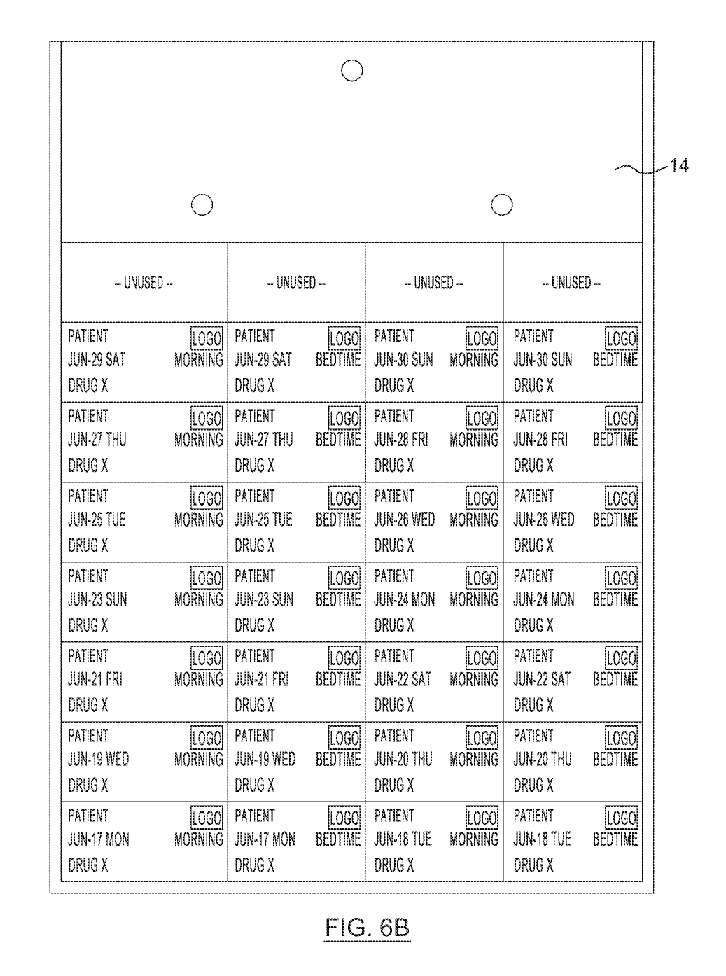

FIGS. 6A and 6B illustrate a scenario where a patient needs medication at two different times per day over a monthly period. This time, only two sets of 32 pill containers are required, instead of three sets of 28 pill containers. Hence, as it can be seen, this new configuration of sets with 32 pill containers results in less waste when used for dosage schedules that cover a monthly period.

The above-described different scenarios can be programmed into software that can be used to manage prescriptions and print out corresponding sealing sheets according to a selected dosage schedule.

More particularly, the present invention also provides a computer program for labeling a sealing sheet as described above. The computer program is tangibly stored on a non-transitory computer-readable medium, containing instructions for causing a computer to:
select at least one prescription associated with a patient record, the patient record for each patient including a patient's name, and the at least one prescription, wherein each prescription is to be administered according to a dosage schedule selected from the group comprising:
   a first dosage form including at least one medicament taken once daily;
   a second dosage form including two groups of medicaments, each group taken at a separate time daily;
   a third dosage form including three groups of medicaments, each group taken at a separate time daily; and
   a fourth dosage form including four groups of medicaments, each group taken at a separate time daily;
and;
print instructions for administration of the selected at least one prescription on the top surface of at least one sealing sheet wherein:
   the selected at least one prescription is printable on one single sealing sheet upon selection of the first dosage form;
   the selected at least one prescription is printable on two sealing sheets upon selection of the second dosage form (as shown in FIGS. 6A and 6B);
   the selected at least one prescription is printable on four sealing sheets upon selection of the third dosage form (as shown in FIGS. 5A to 5D); and
   the selected at least one prescription is printable on four sealing sheets upon selection of the fourth dosage form (as shown in FIGS. 3A to 3D).

According to another embodiment, the at least one prescription can be administered according to an alternate dosage schedule having a another dosage form including a plurality of groups of medicaments, as illustrated in FIGS. 4A to 4D. Each group of medicaments is administrable at a distinct separate administration time daily. Therefore, the selected at least one prescription is printable on a number of sealing sheets corresponding to the number of the plurality of groups of medicaments (in the case of FIGS. 4A to 4D, four sheets), each sealing sheet corresponding to a specific medicament administration time of day. Of course, other types of dosage schedules can be printed in the sealing sheets.

As may be appreciated, numerous modifications could be made to the preferred embodiment disclosed hereinabove without departing from the scope of the present invention. In this connection, it is worth reminding that the present invention, even though it is particularly well adapted to the manufacture of sets of individual pill containers for use in the pharmaceutical field, it could be used in other fields for other applications. It may also be noted that the number of containers may vary from one application to another and the shape and size of each of the containers may be modified as requested.

1. In a sealing sheet for use to close a container-defining sheet having a top surface comprising a given number of spaced apart cavities embossed therein, each of said cavities being upwardly opened and thus defining a container that is surrounded by a flange that is part of the top surface of said container-defining sheet, said sealing sheet comprising:
a top layer having an upper surface and a lower surface, said lower surface being covered with a pressure sensitive adhesive glue; and
a bottom layer having an upper surface detachably fixed to the lower surface of the top layer by means of said adhesive glue, said bottom layer being peelable from the lower surface of the top layer to allow fixation of the sealing sheet onto the top surface of the container-defining sheet, in order to close the containers defined in the same, said bottom layer having tearing lines punched into it in such a manner and position as to leave parts of said bottom layer glued onto the bottom surface of the top layer in the form of a number of bottom pieces equal to the given number of cavities made in the container-defining sheet when said sealing sheet is peeled off, each of said bottom pieces are shaped, sized and positioned so as to extend over a corresponding cavity of the container-defining sheet when the sealing sheet is properly applied to and glued on the flanges of the top surface of the container-defining sheet, said bottom pieces thus preventing any element stored in the containers from coming into contact with the adhesive glue,
the containers defined by the cavities of the container-defining sheet being positioned to form rows and columns,
each row being identifiable with a daily regimen of elements that are storable in the container-defining sheet,
the improvement wherein, in a first configuration, the number of bottom pieces equal to the given number of cavities made in the container-defining sheet is thirty-two, positioned in order to define eight rows and four columns, wherein, at least one row of containers is removable from the container-defining sheet towards a second configuration in which the number of bottom pieces equal to the given number of cavities made in the container-defining sheet is twenty-eight and wherein each row thereby contains four containers corresponding to four different times the elements are to be dispensed from the container.

2. The improved sealing sheet of claim 1, wherein the at least one row of containers removable from the container-defining sheet is frangibly connected to the container-defining sheet

3. The improved sealing sheet of claim 1, wherein the top surface of said sealing sheet comprises information printed on it in such a manner as to be positioned on top of each cover piece and thus to correspond to what is located in the corresponding container.

4. The improved sealing sheet of claim 1, wherein:
the container-defining sheet is intended to store individual pills; and
the sealing sheet is devised to form a corresponding number of cover pieces that are each printed with relevant information as to the content of the corresponding containers and the date the pills contained therein must be taken.

5. The improved sealing sheet of claim 1, wherein:
the container-defining sheet is intended to store individual pills; and
the sealing sheet is devised to form a corresponding number of cover pieces that are each printed with relevant information as to the content of the corresponding containers and the date and daytime period the pills contained therein must be taken.

6. In a set of individual pill containers comprising:
a container-defining sheet made of plastic material, said container-defining sheet having a top surface comprising a given number of spaced apart cavities embossed therein, each of said cavities being upwardly opened and thus defining a container, each of said containers being surrounded by a flange, each of the flanges that are not directly adjacent to one side of the container-defining sheet being provided with a centrally positioned tearing line so to make it possible to detach each of the containers from the adjacent containers and thus from the container-defining sheet whenever desired, and
a sealing sheet made of paper and positioned on top of the top surface of the containing-defining sheet in order to close each of said containers, said sealing sheet being shaped and sized to cover at least all its containers and their surrounding flanges, said sealing sheet being detachably attached to the container-defining sheet by means of a pressure sensitive adhesive glue and being provided with tearing lines positioned to be in superposition on top of the tearing lines of the container-defining sheet to make it possible to tear said sealing sheet into a number of cover pieces corresponding to the number of said containers and thus to detach each of said containers without having to open the same; said sealing sheet comprising:
a top layer made of paper and having an upper surface and a lower surface, said lower surface being covered with the pressure sensitive adhesive glue; and
a bottom layer detachably fixed to the lower surface of the top layer by means of said adhesive glue, said bottom layer being peelable from the lower surface of the top layer to allow fixation of the sealing sheet onto the top surface of the container-defining sheet in order to close the containers of the same, said bottom layer having tearing lines punched into it in such a manner and position as to leave parts of said bottom layer glued onto the bottom surface of the top layer in the form of a number of bottom pieces equal to the given number of cavities made in the container-defining sheet when the sealing sheet is peeled off, each of the said bottom pieces being shaped, sized and positioned so as to extend over a corresponding cavity of the container-defining sheet when the sealing sheet is properly applied to and glued on the flanges on the top surface of said container-defining sheet, such bottom pieces preventing any element stored in the containers from becoming into contact with the adhesive glue;
the containers defined by the cavities of the container-defining sheet being positioned to form rows and columns;
each row or column being identifiable with a daily regimen of elements that are storable in the container-defining sheet;
the improvement wherein, in a first configuration, the number of bottom pieces equal to the given number of cavities made in the container-defining sheet is thirty-two, positioned in order to define eight rows and four columns, wherein, at least one row of containers is removable from the container-defining sheet towards a second configuration in which the number of bottom pieces equal to the given number of cavities made in the container-defining sheet is twenty-eight and wherein each row thereby contains four containers corresponding to four different times the elements are to be dispensed from the container.

7. The improved set of individual pill containers of claim 6, wherein the one row or column of containers removable from the container-defining sheet is frangibly connected to the container-defining sheet

8. The improved set of individual pill containers of claim 6, wherein the top surface of said sealing sheet comprises information printed on it in such a manner as to be positioned on top of each cover piece and thus to correspond to what is located in the corresponding container.

9. The improved set of individual pill containers of claim 6, wherein the sealing sheet is devised to form a corresponding number of cover pieces that are each printed with relevant information as to the content of the corresponding containers and the date the pills contained therein must be taken.

10. The improved set of individual pill containers of claim 6, wherein the sealing sheet is devised to form a corresponding number of cover pieces that are each printed with relevant information as to the content of the corresponding containers and the date and daytime period the pills contained therein must be taken.

11. A computer program for labeling a sealing sheet as claimed in claim 1, the computer program tangibly stored on a non-transitory computer-readable medium, containing instructions for causing a computer to:
select at least one prescription associated with a patient record, the patient record for each patient including a patient's name, and the at least one prescription, wherein each prescription is to be administered according to a dosage schedule selected from the group comprising:
a first dosage form including at least one medicament taken once daily;
a second dosage form including two groups of medicaments, each group taken at a separate time daily;
a third dosage form including three groups of medicaments, each group taken at a separate time daily; and
a fourth dosage form including four groups of medicaments, each group taken at a separate time daily;
and;
print instructions for administration of the selected at least one prescription on the top surface of at least one sealing sheet wherein:
the selected at least one prescription is printable on one single sealing sheet upon selection of the first dosage form;
the selected at least one prescription is printable on two sealing sheets upon selection of the second dosage form;
the selected at least one prescription is printable on four sealing sheets upon selection of the third dosage form; and
the selected at least one prescription is printable on four sealing sheets upon selection of the fourth dosage form.

12. The computer program according to claim 11, wherein the at least one prescription is to be administered according to an alternate dosage schedule having a fifth dosage form including a plurality of groups of medicaments, each group of medicaments being administrable at a distinct separate administration time daily and wherein the selected at least one prescription is printable on a number of sealing sheets corresponding to the number of the plurality of groups of medicaments, each sealing sheet corresponding to a specific medicament administration time of day.
